(19) United States
(12) Patent Application Publication
(10) Pub. No.: US 2016/0311046 A1
(43) Pub. Date: Oct. 27, 2016

(54) Wireless control of a welding machine

(71) Applicant: Antonio Aguilar, Odessa, TX (US)

(72) Inventor: Antonio Aguilar, Odessa, TX (US)

(21) Appl. No.: 14/696,450

(22) Filed: Apr. 26, 2015

(51) Int. Cl. B23K 9/10

(52) U.S. Cl. CPC B23K 9/1087; B23K 9/1006

(57) ABSTRACT

A welding machine for welding an object may include a microprocessor to control the operation of the welding machine; a wireless remote controller to wirelessly control the welding machine and a transceiver to convert the wireless remote controller with the microprocessor.

### FIELD OF THE INVENTION

The present invention relates generally to welding machines and, more particularly, to a method and apparatus for remotely and wirelessly controlling operation of a power source of a welding-type system.

### BACKGROUND

MIG welding, formerly known as Gas Metal Arc Welding (GMAW), combines the techniques and advantages of TIG welding's inert gas shielding with a continuous, consumable wire electrode. An electrical arc is created between the continuous, consumable wire electrode and a workpiece. As such, the consumable wire functions as the electrode in the weld circuit as well as the source of filler metal. MIG welding is a relatively simple process that allows an operator to concentrate on arc control. MIG welding may be used to weld most commercial metals and alloys including steel, aluminum, and stainless steel. Moreover, the travel speed and the deposition rates in MIG welding may be much higher than those typically associated with either Gas Tungsten Arc Welding (TIG) or Shielded Metal Arc Welding (stick) thereby making MIG welding a more efficient welding process. Additionally, by continuously feeding the consumable wire to the weld, electrode changing is minimized and as such, weld effects caused by interruptions in the welding process are reduced. The MIG welding process also produces very little or no slag, the arc and weld pool are clearly visible during welding, and post-weld clean-up is typically minimized. Another advantage of MIG welding is that it can be done in most positions which can be an asset for manufacturing and repair work where vertical or overhead welding may be required.

A wire feeder is operationally connected to the power source and is designed to deliver consumable wire to a weld. To further enhance the operability of the wire feeder of a MIG welding system, known welding systems have connected the power source and the wire feeder to one another across a dedicated control cable that is in addition to a dedicated weld cable such that control signals defining the operational parameters of the power source are transmitted or fed back from the wire feeder to the power source, generally referred to as remote control.

One type of remote control device is used to regulate the operational welding parameters, and switch the welding power source output ON and OFF as well as change the power source mode via a pendant that connects to the power source by a multi-conductor cable. A wire feeder is connected to a power source by a control cable that includes a 14-pin connector. The cable used to transmit operational information to, and in some cases, from the power source may incorporate 2 to 14 conductors depending on how many functions are to be controlled. Separately connected between the power source and wire feeder is a high voltage weld cable that delivers welding power to the wire feeder and creates a voltage potential between an electrode and a workpiece.

A significant drawback to this control cable-based scheme is that the control cable is typically fragile relative to the welding cables designed to carry high currents at high voltages. Welding machines are commonly used at construction sites or shipyards where it is not uncommon for the welding machines to be periodically relocated or surrounded by other mobile heavy equipment operating in the same area. As such, the remote control cable can become damaged by being crushed or snagged from contact with surrounding machines and/or traffic. This can cause damage to the wire feeder and/or the welding power source if internal power conductors become shorted to signal leads that are connected to sensitive signal level circuitry (See U.S. Pat. No. 7,902,484).

MIG and TIG welders use inert gas to remove the oxygen from the arc meal metal, to avoid the oxidation, consequently, this kind of welder is normally used indoor because the wind removes the inert gas and oxidation takes place, having defective welds.

In some applications, the welder operator may not have easy access to the welder machine.

### EXAMPLES

Building construction, Oil platforms, Derricks, oil field, Plants, etc. and use mainly rod electrode, because it is outdoor job.

When a welder is working on a pipeline normally needs a helper because the helper changes the settings on the welder machine when the welder indicates, this settings depends of work position. It would be desirable to eliminate the need for the helper.

### SUMMARY

A welding machine for welding an object may include a microprocessor to control the operation of the welding machine; a wireless remote controller to wirelessly control the welding machine and a transceiver to convert the wireless remote controller with the microprocessor.

The transceiver is to transmit and receive RF signal and, data and commands

The microprocessor may provide automatic control of the welding machine.

The remote control may only can set settings present on the welder machine front panel, like: start, stop, select current, select digging and so on, desired by the operator. One can see it like an extent of the welder machine FRONT PANEL plus some practical functionality like pipe mode and automatic start and stop engine.

The microprocessor may provide pipe mode control of the welding machine to replace the action of the welder helper that may include increasing or decreasing the current when the operator needs to do it, according to the welder position.

The microprocessor may control the welding current by pulse width modulation when is operating in an electric welder machine field current controlled.

The microprocessor may control an AC load sensor to start the engine when power is demanded.

The automatic control may set a predetermined time to stop the welding machine when the machine is in idle state.

The automatic control may start the welding machine when power is demanded.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a circuit diagram of the present invention.

### DETAILED DESCRIPTION

There are electronic controlled welders and electric controlled welders. normally the electronic controlled welders are three phase AC generators, and converts the AC to DC by rectifier bridges, and then controls the output welding current by a “chopping techniques” PWM. Normally, normally this kind of machine have a potentiometer POT to adjust the output welding current.

The electric controlled welder machines of the present invention includes a DC generator and uses a rheostat to control directly the field current, now controlling the field current, “magnetic field” on the DC generator controls the output welding current, so the present invention is capable of control, electronic controlled welder machines and electric welder machines, only changes the method.

For electric welder machines where welding current is controlled by modifying the field current by a rheostat, then uses a PWM to control the field current, and optionally can use a small step motor to rotate the original rheostat to the correct position, depending of the desired current, the position sensor is required when the system starts to determine the initial position of the rheostat, after that it do not needs position sensor because the system has in memory the current position of the step motor.

For electronic controlled welders using a mechanical POT to control the output welding current,

The mechanic mechanical POT is replaced by a digital POT and this can be operated by digital signal to make the job.

The present invention is applicable to the welding field, and the present invention includes a RF (Radio Frequency) remote control for welding machines 103. The users of the present invention may control any setting on the machine 103 remotely and without wires, for example current arc digging, flat welding and down hill welding and other applications. The present invention may be used in engine powered welders or in power line feed led welders, moreover, the present invention may include operation modes, automatic mode and pipe mode.

The automatic mode may include on set a predetermined time to stop the engine, so the controller may stop the engine after a predetermined time in the idle state, and the controller may start the engine when power is demanded such as when the user touches the metal with the welding rod or when the user starts an electric tool.

Pipe mode, Pipe welding demands different capabilities because the current required for welding needs to be changed depending on the position of the arc on the pipe. Under these circumstances, the welder needs a helper to change the current in the machine when welding is in process. The present invention permits the welder to increase or decreases the current in steps predetermined by the welder without stopping the arc himself. By simply activating one of a multitude push buttons, the current increases or decreases (increases and decreases) and by pushing another push button, the current value returns to the initial setting.

More particularly activating one of two push buttons, the current increases or decreases. By pushing both push buttons together, the current value returns to the initial setting.

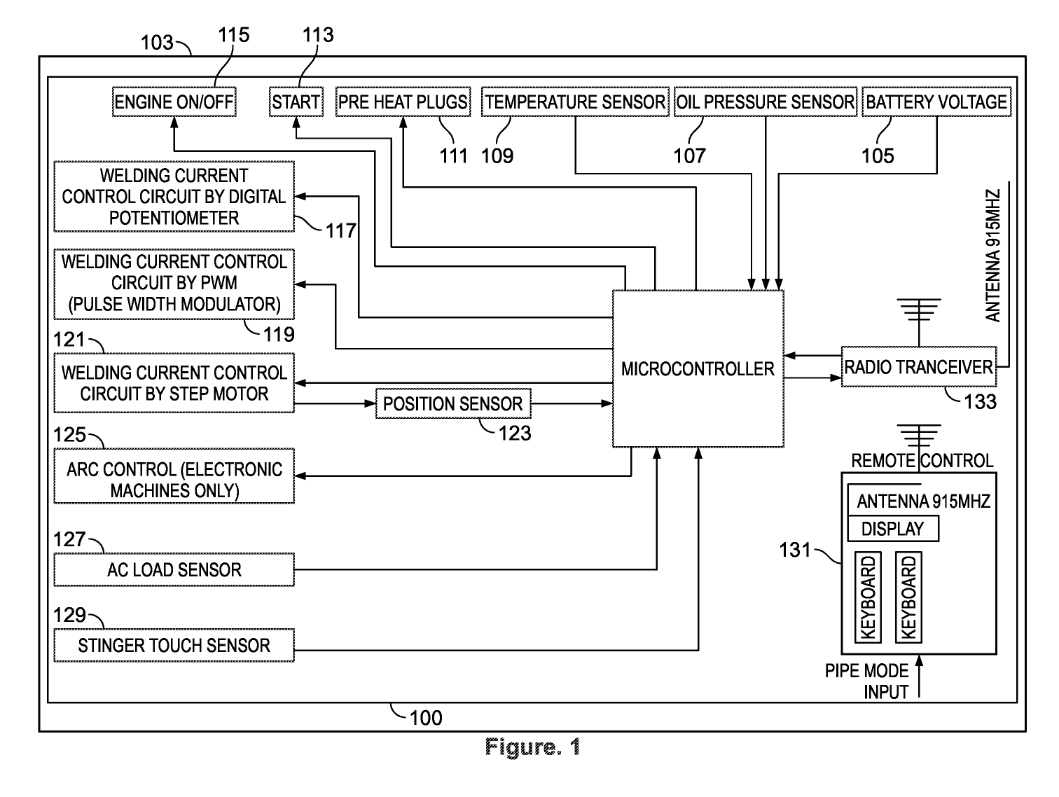

FIG. 1 illustrates a control circuit 100 for a welding apparatus 103 of the present invention which may include a microcontroller 101 to control the operation of the welding apparatus 103 which may be connected to a battery voltage circuit 105, an oil pressure sensor 107, a temperature sensor 109, preheat plug circuit 111, a start control circuit 113, an engine on off switch 115, a welding current control circuit by digital potentiometer in the electronic controlled welder machines 117, a welding current control circuit by pulse width modulator (PWM) in electric welder machines, field current controlled, a optional method for electric welding machines field current may be controlled by rheostat rotate the original rheostat by step motor 121 which may be connected to a position sensor 123, and arc control circuit 125 for electronic machines only, AC load sensor 127 and a stinger touch sensor circuit 129. The microcontroller 101 may be controlled by remote control 131 which may include a display, an antenna and a keyboard. The remote control 131 transmits and receives signals to and from the microcontroller 101 by connection with the receiver 133 which may be connected to the microcontroller 101. The micro controller 101 controls the welding machine 103.

The engine on/off switch 105 allows the engine to run or be shut off and the start switch 113 starts the engine. The pre-heat plugs circuit 111 and may be used to preheat the plugs of the welding machine 103 during cold weather. The microcontroller 101 senses the temperature and determines if the plugs need to be heated and determines the length of time that the plugs need to be preheated. The temperature sensor 109 senses the engine coolant temperature and transmits the temperature signal to the microprocessor 101 and to control the preheat plugs circuit 111. The oil pressure sensor 107 senses the pressure of the oil in the engine of the welding machine 103 to determine if the engine is running or not and the oil pressure signal is transmitted to the microcontroller 101.

The battery voltage circuit 105 may be used to determine the exact time that the engine of the welding machine 103 starts. During the starting process, the battery voltage is monitored by the microprocessor 101 to determine when the engine starts. When the engine starts, the electric start motor current is reduced and the voltage across the battery increases. A measure of the battery voltage is transmitted to the microprocessor 101.

The welding current is controlled by the following circuits. The digital potentiometer control circuit 117 controls the welding current, a pulse width modulator circuit 119 (PWM) may control the field current of the field current welding machine (electric controlled welder machines). The widths of the digital pulses are varied to control the field current. The PWM circuit 119 may replace a rheostat and may be under the control of the microprocessor 101. A step motor 121 may be an alternative to a welding machine using a rheostat to control the field current as the step motor may rotate the rheostat to the correct position for the desired field current. The steep motor 121 may be under the control of the microprocessor 101. The step motor 121 may include a position sensor 123 to detect the position of the motor and inputs the position to the microcontroller 101. The arc control circuit 125 may be used to control the arc in welding machines 103 using electronic control and is controlled by the microprocessor 101.

The microprocessor 101 senses when the engine has been in a predetermined time in idle state and after that the microcontroller 101 stops the engine and senses if there is a power demand. When power demand is sensed (AC load sensor 127 or welding current stinger load sensor 129) then the microcontroller 101 starts the engine and activate the welding machine 103.

The receiver/transmitter radio transceiver 133 wirelessly may connect with the remote control 131 to transmit and receive signals from the remote control 131. More particularly the radio transceiver 133 may receive commands and data values from the remote control, and the microprocessor 101 executes the commands and data values and acknowledges the receipt of the remote control 131 by sending a signal through the radio transceiver 133.

The remote control 131 can enable the user to select a command for the microprocessor 101 and optionally a data value for the microprocessor 101 such as a setting for the welding machine. To operate the welding machine in the pipe mode, the user may operate two keys or two push buttons to actuate the welding machine during the welding process. Without stopping welding, one pushbutton may be to increase the Delta amps and another button to decrease the Delta amps. The user may return to a base value by pressing both buttons together. The user may set the increment to increase or decrease (Delta value) which may be any value between 1 and 10 per step.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A welding machine for welding an object, comprising:
a microprocessor to control the operation of the welding machine;
a wireless remote controller to wirelessly control the welding machine;
a transceiver to convert the wireless remote controller with the microprocessor.

2) A welding machine for welding an object as in claim 1, wherein the microprocessor provides automatic control of the welding machine.

3) A welding machine for welding an object as in claim 1, wherein the microprocessor provides pipe mode control of the welding machine.

4) A welding machine for welding an object as in claim 1, wherein the microprocessor controls the welding current by pulse width modulation.

5) A welding machine for welding an object as in claim 1, wherein the microprocessor controls an AC load sensor.

6) A welding machine for welding an object as in claim 2, wherein the automatic control sets a predetermined time to stop the welding machine

7) A welding machine for welding an object as in claim 2, wherein the automatic control starts the welding machine when power is demanded.
